(19) United States
(12) Patent Application Publication
(10) Pub. No.: US 2025/0183489 A1
(43) Pub. Date: Jun. 5, 2025

(54) ENERGY STORAGE APPARATUS

(71) Applicant: GS Yuasa International Ltd., Kyoto-shi, Kyoto (JP)

(72) Inventor: Yosuke NISHIMURA, Kyoto-shi, Kyoto (JP)

(21) Appl. No.: 18/832,386

(22) PCT Filed: Jan. 19, 2023
(86) PCT No.: PCT/JP2023/001440

§ 371 Date: Jul. 23, 2024

(30) Foreign Application Priority Data
Jan. 26, 2022 (JP) JP 2022-010012

(51) Int. Cl. H01M 50/503; H01G 11/10; H01M 50/209; H01M 50/296; H01M 50/507

(52) U.S. Cl. CPC H01M 50/503; H01M 50/209; H01M 50/296; H01M 50/507; H01G 11/10

(57) ABSTRACT

An energy storage apparatus according to the present embodiment includes: a stack of energy storage devices; a pair of terminal members sandwiching the stack in a first direction; and a coupling member coupling, with each other, ends of the terminal members, in which the terminal member includes a plate-shaped terminal-member main-body, the terminal-member main-body includes: a first side elongating along a second direction; and a second side elongating along a third direction, the coupling member includes: a coupling-member main-body adjacent to the stack; a first piece elongating along the stack from an end in the third direction of the coupling-member main-body; a second piece elongating along the terminal-member main-body, from an end in the first direction of the coupling-member main-body; and a coupling portion coupling the first piece and the second piece, and each of a first edge in which the first side is linked to the second side in the terminal-member main-body and a second edge including respective edges of the coupling portion and the second piece includes an opposing portion opposing in a manner to intersect, and an end of at least one of the terminal member and the coupling portion, which includes the opposing portion, is curved with respect to a portion adjacent to that end, so as to be away from an opposing portion of the counterpart.

### TECHNICAL FIELD

The present invention relates to an energy storage apparatus including an energy storage device.

### BACKGROUND ART

Conventionally, a power supply apparatus that includes a plurality of battery cells is known (refer to Patent Literature 1). As illustrated in FIG. 17 and FIG. 18, this power supply apparatus 500 includes: a battery cell stack 502 made by stacking a plurality of battery cells 501; a pair of end plates 503 disposed at both ends of this battery cell stack 502 in the stacking direction; and bind bars 504 fixed to the end plates 503.

A battery cell 501 has an outer shape whose thickness is narrower than its width. A plurality of such battery cells 501 are stacked, with their main surfaces being in a rectangular shape. Specifically, the battery cell 501 has an outer can making up its outer shape, which is made in a rectangular shape whose thickness is narrower than its width.

The pair of end plates 503 cover both end surfaces of the battery cell stack 502, in a state in which the battery cells 501 are alternately stacked with separators 505 therebetween. This pair of end plates 503 sandwich the battery cell stack 502 by being fixed by the bind bars 504. Each end plate 503 is made up of a single metal plate.

Each bind bar 504 has a main-body plate 506, the both ends of which are fixed to the end plates 503. The main-body plates are disposed at both side surfaces of the battery cell stack 502 to which the end plates 503 are stacked to their both ends. The ends of the main-body plates are fixed to the pair of end plates 503.

Specifically, the main-body plate 506 is formed in a plate shape elongating in a battery stacking direction of the battery cell stack 502. More specifically, the main-body plate 506 includes a fastened main surface 507, in a flat plate shape, covering a side surface of the battery cell stack 502. The main-body plate 506 also includes a first bent piece 508, a second bent piece 509, a third bent piece 510, and a fourth bent piece 511, as bent pieces obtained by bending the edges of the main-body plate 506.

The first bent piece 508 is a top bent piece obtained by bending a top side of the main-body plate 506. The second bent piece 509 is a bottom bent piece obtained by bending a bottom side of the main-body plate 506, and partially covers the corner portions of the lower surface of the battery cell stack 502. The third bent piece 510 is an end-plate fixing piece, which is obtained by partially bending a front side of the main-body plate 506. The fourth bent piece 511 is an end-plate fixing piece, which is obtained by partially bending a rear side of the main-body plate 506.

This main-body plate 506 is manufactured by a bending process of a metal plate, and is fixed to the end plates 503 with the end-plate fixing pieces by screwing.

In the power supply apparatus 500 configured in the above manner, the battery cell stack 502 is sandwiched by the pair of end plates 503 and the bind bars 504 with a large power in the stacking direction. For this reason, in recent years, each configuration of the power supply apparatus 500 is required to have sufficient rigidity.

In the corner portion of the bind bar 504, it is considered possible to improve rigidity of a bind bar 504 (specifically, the main-body plate 506), by coupling ends, to each other, respectively corresponding to a top bent piece (the first bent piece 508) and an end-plate fixing piece (the third bent piece 510, the fourth bent piece 511).

In such a configuration, however, an edge (circumference) of an end plate 503 and an edge of the coupled portion of the main-body plate 506 interfere (abut) with each other by opposing in a manner to intersect with each other. This causes a large stress concentration in this abutted portion, and damage to the main-body plate 506 and the end plate 503 is a potential issue.

### CITATION LIST

### Patent Literature

Patent Literature 1: Japanese Patent Application Publication No. 2021-26875

### DISCLOSURE OF INVENTION

### Problems to be Solved by the Invention

An objective of the present embodiment is to provide an energy storage apparatus which can restrain interference between an edge of a terminal member and an edge of a coupling member.

### Means for Solving the Problems

An energy storage apparatus according to the present embodiment includes: a stack including a plurality of energy storage devices aligning in a first direction; a pair of terminal members sandwiching the stack in the first direction; and a coupling member coupling, with each other, corresponding ends in a second direction orthogonal to the first direction of the pair of terminal members, where at least one terminal member of the pair of terminal members includes a terminal-member main-body extending in a direction orthogonal to the first direction, when viewed in the first direction, the terminal-member main-body includes: first sides elongating along the second direction at respective ends in a third direction orthogonal to each of the first direction and the second direction of the terminal-member main-body; and second sides elongating along the third direction at respective ends in the second direction of the terminal-member main-body, the coupling member includes: a coupling-member main-body elongating in the first direction at a position adjacent to the stack in the second direction; a first piece elongating along a direction approaching the stack in the second direction from an end of the coupling-member main-body on one side in the third direction and elongating in the first direction; a second piece elongating in the second direction along a surface of the terminal-member main-body on a side opposite to the stack, from an end of the coupling-member main-body on one side of the first direction and elongating in the third direction; and a coupling portion coupling corresponding ends of the first piece and the second piece, and each of a first edge being an edge of a portion in which the first sides are linked to the second sides in the terminal-member main-body and a second edge including respective edges of the coupling portion and the second piece includes an opposing portion opposing in a manner to intersect, and an end of at least one of the terminal member and the coupling portion, which includes the opposing portion, is curved with respect to a portion adjacent to the end, so as to be away from an opposing portion of the counterpart.

### Effect of the Invention

Based on the above, the present embodiment can provide an energy storage apparatus which can restrain interference between an edge of a terminal member and an edge of a coupling member.

### BRIEF DESCRIPTION OF DRAWINGS

FIG. 1 is a perspective view of an energy storage apparatus according to the present embodiment.

FIG. 2 is a front view of the energy storage apparatus.

FIG. 3 is a plan view of the energy storage apparatus.

FIG. 4 is an enlarged view of a portion indicated by IV in FIG. 3.

FIG. 5 is an exploded perspective view of the energy storage apparatus in which a portion of its configuration is omitted.

FIG. 6 is a front view of a terminal member included in the energy storage apparatus.

FIG. 7 is an exploded perspective view of the terminal member.

FIG. 8 is an exploded perspective view of the terminal member.

FIG. 9 is a front view of a second member included in the terminal member.

FIG. 10 is a side view of the second member.

FIG. 11 is an enlarged side view of an end of the second member on one side in a Z-axis direction.

FIG. 12 is a partial enlarged view of a corner portion of the terminal member and its surrounding portion, as viewed from a side of the first member.

FIG. 13 is a side view of a coupling member included in the energy storage apparatus, in which its middle portion is omitted.

FIG. 14 is a front view of the coupling member.

FIG. 15 is a plan view of the coupling member, in which its middle portion is omitted.

FIG. 16 is an enlarged perspective view of an end of the coupling member.

FIG. 17 is a perspective view of a conventional power supply apparatus.

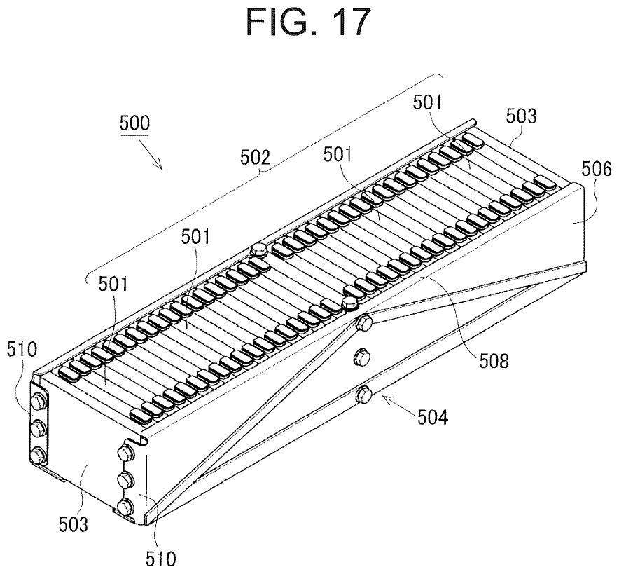

FIG. 18 is an exploded perspective view of the power supply apparatus.

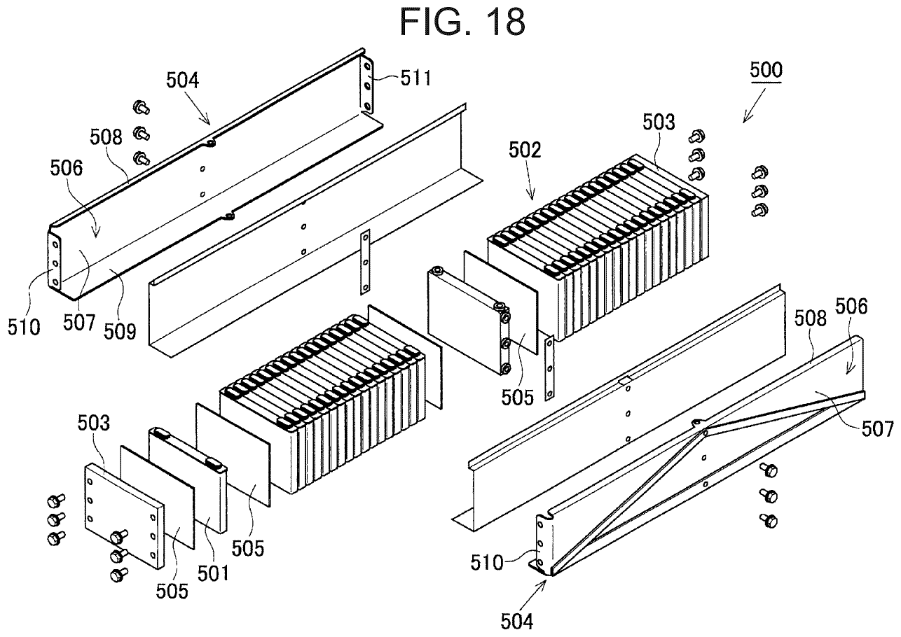

### DESCRIPTION OF EMBODIMENTS

(1) An energy storage apparatus according to the present embodiment includes: a stack including a plurality of energy storage devices aligning in a first direction; a pair of terminal members sandwiching the stack in the first direction; and a coupling member coupling, with each other, corresponding ends in a second direction orthogonal to the first direction of the pair of terminal members, where at least one terminal member of the pair of terminal members includes a terminal-member main-body extending in a direction orthogonal to the first direction, when viewed in the first direction, the terminal-member main-body includes: first sides elongating along the second direction at respective ends in a third direction orthogonal to each of the first direction and the second direction of the terminal-member main-body; and second sides elongating along the third direction at respective ends in the second direction of the terminal-member main-body, the coupling member includes: a coupling-member main-body elongating in the first direction at a position adjacent to the stack in the second direction; a first piece elongating along a direction approaching the stack in the second direction from an end of the coupling-member main-body on one side in the third direction and elongating in the first direction; a second piece elongating in the second direction along a surface of the terminal-member main-body on a side opposite to the stack, from an end of the coupling-member main-body on one side of the first direction and elongating in the third direction; and a coupling portion coupling corresponding ends of the first piece and the second piece, and each of a first edge being an edge of a portion in which the first sides are linked to the second sides in the terminal-member main-body and a second edge including respective edges of the coupling portion and the second piece includes an opposing portion opposing in a manner to intersect, and an end of at least one of the terminal member and the coupling portion, which includes the opposing portion, is curved with respect to a portion adjacent to the end, so as to be away from an opposing portion of the counterpart.

The above-described configuration can restrain interference between the edge (the opposing portion included in the edge) of the terminal member and the edge (the opposing portion included in the edge) of the coupling member.

(2) In the energy storage apparatus according to the above (1), in the energy storage apparatus according to the present embodiment, the terminal-member main-body may include: the end which includes the opposing portion, and a fixed portion to which the second piece is fixed, and in the terminal-member main-body, the end including the opposing portion may be adjacent to the fixed portion.

When a large binding force in the first direction is exerted on the stack by coupling the pair of terminal members by the coupling member, this configuration can restrain interference between the edges of the terminal member and the coupling member, at positions where a large force is likely to occur, when the edges interfere with each other.

(3) In the energy storage apparatus according to the above (1) or (2), in the energy storage apparatus according to the present embodiment, the terminal-member main-body may include a first member and a second member aligning in the stated order towards a direction away from the stack in the first direction and being in contact with each other, the second member may include the end including the opposing portion, and either a portion of the first member, which corresponds to the end of the second member including the opposing portion, may not be in contact with the second member, or the first member may not be disposed in an area overlapping the end of the second member including the opposing portion, when viewed in the first direction.

In this way, overlapping (aligning) the first member and the second member can restrain interference between the edges of the terminal member and the coupling member, while maintaining the strength of the terminal member.

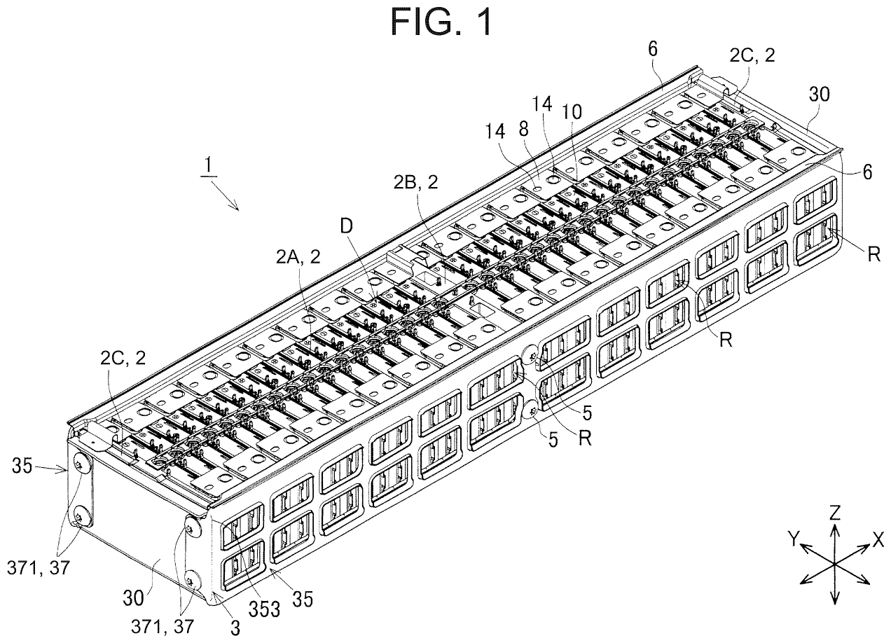

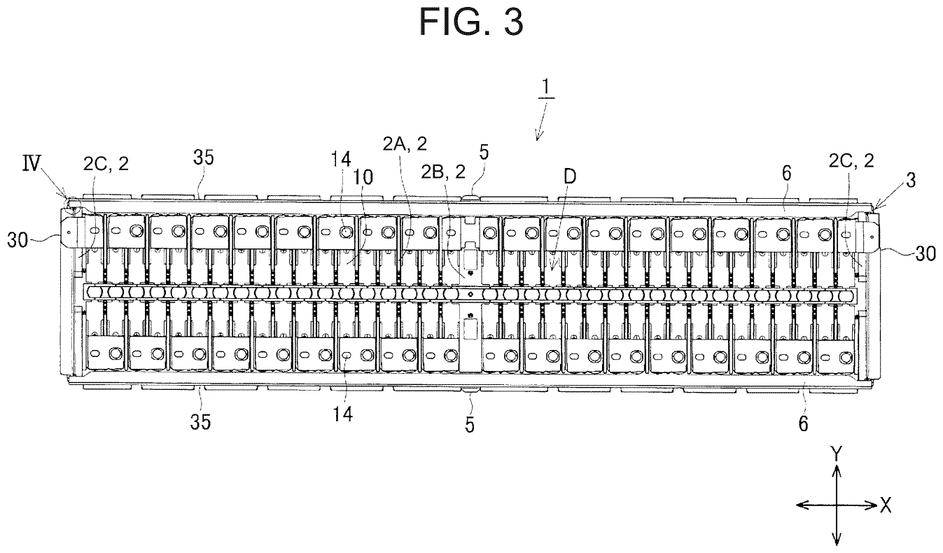

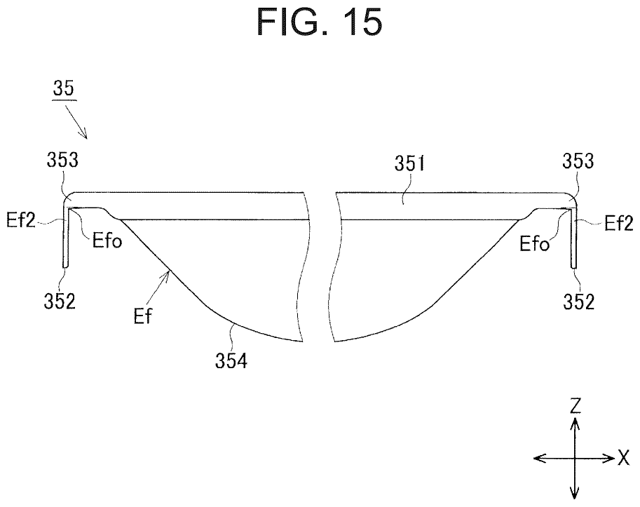

The following describes an embodiment of the present invention with reference to FIG. 1 to FIG. 16. Note that the name of each constituting member (constituting element) of the present embodiment is the name for the present embodiment, and may be different from the name of that constituting member (constituting element) used in BACKGROUND ART.

As illustrated in FIG. 1 through FIG. 5, the energy storage apparatus 1 includes: a stack D including a plurality of energy storage devices 10 aligning in a predetermined direction; a pair of terminal members 30 sandwiching the stack D in the predetermined direction; and coupling members 35 coupling the pair of terminal members 30 with each other. Specifically, the energy storage apparatus 1 according to the present embodiment includes: a stack D in which energy storage devices 10 and adjacent members 2 align alternately in the predetermined direction; and a holding member 3 including terminal member 30 and coupling member 35, and holding the stack D. The energy storage apparatus 1 includes: a first fastening member 5 fixing at least one adjacent member 2 to the holding member 3; at least one insulator 6 disposed between the stack D (specifically, the plurality of energy storage devices 10 included in the stack D) and the holding member 3; and a plurality of bus bars 8 coupling different energy storage devices 10 with each other to be electrically conductible.

Each of the plurality of energy storage devices 10 is a primary battery, a secondary battery, a capacitor, etc. The energy storage device 10 according to the present embodiment is a chargeable and dischargeable non-aqueous electrolyte secondary battery.

More specifically, the energy storage device 10 is a lithium-ion secondary battery which uses electron transfer that takes place as lithium ions transfer.

Specifically, each energy storage device 10 includes: an electrode assembly, a case 11 to accommodate the electrode assembly together with an electrolyte; an external terminal 14 being at least partially exposed outside the case 11; and a current collector to couple the electrode assembly with the external terminal 14.

In the electrode assembly, a positive electrode and a negative electrode are alternately stacked with a separator interposed therebetween. In this electrode assembly, the energy storage device 10 charges and discharges, as lithium ions transfer between the positive electrodes and the negative electrodes.

The case 11 includes: a case main-body 12 having an opening; and a cover plate 13, in a plate shape, to close (seal) the opening of the case main-body 12. This case main-body 12 has a rectangular cylindrical shape in which an end on one side in the opening direction is closed (i.e., a rectangular cylindrical shape with a bottom), and the case 11 has a rectangular parallelepiped shape (hexahedron shape).

Specifically, the case main-body 12 includes: a closing portion 121 in a plate shape; and a cylindrical drum portion (peripheral wall) 122 coupled to a circumference of the closing portion 121.

The closing portion 121 is a portion which is disposed at a bottom end of the case main-body 12, when the case main-body 12 is disposed in such a posture that the opening is oriented upward. That is, the closing portion 121 serves as a bottom wall of the case main-body 12 when the opening is oriented upward.

The closing portion 121 has a rectangular shape when viewed in a normal direction of the closing portion 121.

The drum portion 122 has a rectangular cylindrical shape. In more detail, the drum portion 122 has a flat rectangular cylindrical shape. The drum portion 122 includes: a pair of long wall portions 123 elongating from the long sides of the circumference of the closing portion 121; and a pair of short wall portions 124 elongating from the short sides of the circumference of the closing portion 121. In this drum portion 122, the short wall portions 124 respectively couple the corresponding ends of the pair of long wall portions 123, thereby forming the drum portion 122 having a rectangular cylindrical shape.

The cover plate 13 is a member, in a plate shape, to close the opening of the case main-body 12. This cover plate 13 is joined to the case main-body 12 in a state in which a circumferential portion of the cover plate 13 is overlapped on a circumferential portion of the opening of the case main-body 12, thereby forming the case 11.

The above-described case 11 has a flat rectangular parallelepiped shape, and the plurality of energy storage devices 10 align in the predetermined direction in a state in which the wide surfaces (the long wall portions 123) of the cases 11 oppose each other.

The external terminal 14 is a portion to be electrically coupled to an external terminal of another energy storage device 10 or to an external device, or the like. The external terminal 14 is formed by a conductive member. For example, the external terminal 14 is formed by a metal material having high weldability, such as an aluminum-based metal material such as aluminum or an aluminum alloy or a copper-based metal material such as copper or a copper alloy.

In the description stated below, the direction in which the plurality of energy storage devices 10 align (first direction) is defined to be X-axis of a rectangular coordinate system, the direction (second direction) in which the short wall portions 124 of the case 11 oppose is defined to be Y-axis of the rectangular coordinate system, and the direction in which the cover plate 13 opposes the closing portion 121 is defined to be Z-axis (third direction).

The adjacent member 2 has an insulating property and is disposed between the energy storage devices 10 aligning in the X-axis direction, or between an energy storage device 10 and a member aligning relative to the energy storage device 10 in the X-axis direction (a part of a holding member 3 in the example of the present embodiment). The adjacent member 2 according to the present embodiment is formed of resin. A flow path (flow path space) R is formed between this adjacent member 2 and an energy storage device 10 adjacent thereto, through which a fluid for temperature adjustment (gas such as air in the example of the present embodiment) can flow. The energy storage apparatus 1 according to the present embodiment includes a plurality of adjacent members 2, and the plurality of adjacent members 2 include a plurality of types of adjacent members 2A, 2B, and 2C.

Specifically, the plurality of adjacent members 2 include a first adjacent member 2A disposed between two adjacent energy storage devices 10, a second adjacent member 2B disposed between adjacent energy storage devices 10 and fixed to the holding member 3, and a third adjacent member 2C disposed between the holding member 3 and an energy storage device 10 closest to the end in the X-axis direction to be adjacent to that energy storage device 10. In other words, the energy storage apparatus 1 includes, as the adjacent members 2, the first adjacent member 2A, the second adjacent member 2B, and the third adjacent member 2C. The energy storage apparatus 1 according to the present embodiment includes a plurality of first adjacent members 2A, a single second adjacent member 2B, and two (a pair of) third adjacent members 2C. Each of the plurality of first adjacent members 2A is disposed between energy storage devices 10 excluding between those energy storage devices 10 between which the second adjacent member 2B is disposed.

Each of the plurality of first adjacent members 2A includes: a first main-body portion 21A extending in a direction orthogonal to the X-axis direction between the energy storage devices 10 adjacent to each other in the X-axis direction; and at least one first restricting portion 25A restricting movement of the energy storage device 10 adjacent to the first main-body portion 21A relative to the first main-body portion 21A. Each of the plurality of first adjacent members 2A forms at least one flow path R through which a temperature adjusting fluid can flow, between that first adjacent member 2A and the energy storage device 10 adjacent thereto.

The first main-body portion 21A is a portion opposing the long wall portion 123 of the case 11 of the energy storage device 10 with a portion thereof abutting the long wall portion 123. This first main-body portion 21A forms a flow path R through which a fluid for temperature adjustment can flow, between this first main-body portion 21A and the energy storage device 10 adjacent thereto. The first main-body portion 21A according to the present embodiment has a rectangular shape in a size corresponding to the energy storage device 10 when viewed in the X-axis direction, and has a rectangular waveform cross-sectional shape along a X-Z plane (plane including the X-axis direction and the Z-axis direction).

The first restricting portion 25A elongates in the X-axis direction from at least a corner-edge portion of the first main-body portion 21A having a rectangular shape, and abuts the energy storage device 10 (specifically, the case 11) adjacent to the first main-body portion 21A from outside in a Y-Z plane (plane including the Y-axis direction and the Z-axis direction) direction, thereby restricting relative movement of that energy storage device 10 relative to the first main-body portion 21A in the Y-Z plane direction. The first restricting portion 25A according to the present embodiment respectively elongates to one side and the other side in the X-axis direction from the first main-body portion 21A.

The second adjacent member 2B includes: a second main-body portion 21B extending in a direction (Y-Z plane direction) orthogonal to the X-axis direction between adjacent two energy storage devices 10; and a second fastening member 22B used to fix that second adjacent member 2B to the holding member 3. The second adjacent member 2B includes at least one second restricting portion 25B to restrict movement of an energy storage device 10 adjacent to the second main-body portion 21B, relative to that second main-body portion 21B. The second adjacent member 2B also forms at least one flow path R through which a temperature adjusting fluid can flow, between that second adjacent member 2B and the energy storage device 10 adjacent thereto.

The second main-body portion 21B is a portion opposing the long wall portion 123 of the case 11 of the energy storage device 10 with a portion thereof abutting the long wall portion 123. This second main-body portion 21B forms a flow path R through which a fluid for temperature adjustment can flow, between this second main-body portion 21B and the energy storage device 10 adjacent thereto. A size of this second main-body portion 21B in the X-axis direction is larger than the size of the first main-body portion 21A in the X-axis direction (that is, the second main-body portion 21B is thicker). The second main-body portion 21B according to the present embodiment has a rectangular shape in a size corresponding to the energy storage device 10 when viewed in the X-axis direction. This second main-body portion 21B includes a plurality of convex stripes 211B, which respectively elongate in the Y-axis direction and align with an interval therebetween in the Z-axis direction. The plurality of convex stripes 211B protrude from an opposing surface 212B of the second main-body portion 21B, the opposing surface 212B opposing the energy storage device 10.

The second fastening members 22B are disposed at respective ends of the second main-body portion 21B in the Y-axis direction. The plurality of second fastening members 22B engage with the first fastening members 5, respectively, to fasten the second adjacent member 2B and the holding member 3. Each second fastening member 22B according to the present embodiment is an insert nut. Each first fastening member 5 according to the present embodiment is a bolt, and engages (is screwed into) the second fastening member 22B while being inserted in the holding member 3, thereby fastening the second adjacent member 2B and the holding member 3.

The second restricting portion 25B elongates in the X-axis direction from at least a corner-edge portion of the second main-body portion 21B having a rectangular shape, and abuts the energy storage device 10 (specifically, the case 11) adjacent to the second main-body portion 21B from outside in the Y-Z plane direction, thereby restricting relative movement of that energy storage device 10 relative to the second main-body portion 21B in the Y-Z plane direction. The second restricting portions 25B according to the present embodiment respectively elongate to one side and the other side in the X-axis direction from the second main-body portion 21B.

Each of two third adjacent members 2C includes: a third main-body portion 21C extending in a direction orthogonal to the X-axis direction between an energy storage device 10 and a part of the holding member 3 (the terminal member 30 in the example of the present embodiment) adjacent to each other; and at least one third restricting portion 25C restricting movement of the energy storage device 10 adjacent to the third main-body portion 21C relative to that third main-body portion 21C. Each of the two third adjacent members 2C forms at least one flow path R through which a temperature adjusting fluid can flow, between that third adjacent member 2C and the energy storage device 10 adjacent thereto.

The third main-body portion 21C is a portion opposing the long wall portion 123 of the energy storage device 10 with a portion thereof abutting the long wall portion 123. Just as the first main-body portion 21A of the first adjacent member 2A and the second main-body portion 21B of the second adjacent member 2B, this third main-body portion 21C also forms a flow path R through which a fluid for temperature adjustment can flow, between this third main-body portion 21C and the energy storage device 10 adjacent thereto. The third main-body portion 21C according to the present embodiment has a rectangular shape in a size corresponding to the energy storage device 10 when viewed in the X-axis direction. This third main-body portion 21C includes a plurality of convex stripes 211C, which respectively elongate in the Y-axis direction and align with an interval therebetween in the Z-axis direction. The plurality of convex stripes 211C protrude from an opposing surface 212C of the third main-body portion 21C, the opposing surface 212C opposing the energy storage device 10.

The third restricting portion 25C elongates in the X-axis direction from at least a corner-edge portion of the third main-body portion 21C having a rectangular shape, and abuts the energy storage device 10 (specifically, the case 11) adjacent to the third main-body portion 21C from outside in the Y-Z plane direction, thereby restricting relative movement of that energy storage device 10 relative to the third main-body portion 21C in the Y-Z plane direction. The third restricting portion 25C according to the present embodiment elongates to one side (towards the energy storage device 10) in the X-axis direction from the third main-body portion 21C.

The holding member 3 encloses around the stack D, which includes the plurality of energy storage devices 10 and the plurality of adjacent members 2, thereby holding that stack D. That is, the holding member 3 collectively holds the plurality of energy storage devices 10 and plurality of adjacent members 2, by enclosing around the plurality of energy storage devices 10 and plurality of adjacent members 2. This holding member 3 is made up of a conductive member made of metal or the like.

Specifically, the holding member 3 includes: a pair of terminal members 30 disposed at both sides of the stack D in the X-axis direction; and coupling member 35 elongating in the X-axis direction, at a position adjacent to the stack D in the Y-axis direction. The holding member 3 according to the present embodiment includes a pair of coupling members 35 disposed with an interval therebetween in the Y-axis direction. The pair of coupling members 35 couple respective ends, with each other, of the pair of terminal members 30 in the Y-axis direction. The holding member 3 includes at least one fastening member 37 to fasten the terminal members 30 and the coupling members 35. The holding member 3 according to the present embodiment includes a plurality of fastening members 37.

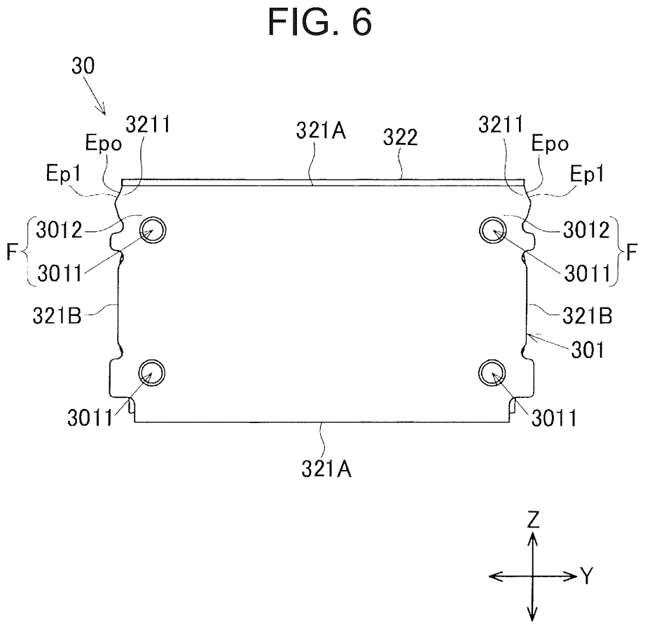

As illustrated in FIG. 6, each of the pair of terminal members 30 includes a terminal-member main-body 301 extending in a direction orthogonal to the X-axis direction. This terminal-member main-body 301 has a rectangular shape and includes, when viewed in the X-axis direction: first sides 321A elongating along the Y-axis direction on respective ends of the terminal-member main-body 301 in the Z-axis direction; and second sides 321B elongating along the Z-axis direction on respective ends each of the terminal-member main body 301 in the Y-axis direction. This terminal-member main-body 301 has a rectangular shape in a size corresponding to the energy storage device 10, and includes coupling through holes 3011 penetrating in the X-axis direction, in four corners thereof. That is, the terminal member 30 includes four coupling through holes 3011. This coupling through hole 3011 and the through hole circumferential portion 3012 of the coupling through hole 3011 constitute a fixed portion F used to fix (couple) the coupling member 35 to the terminal member 30.

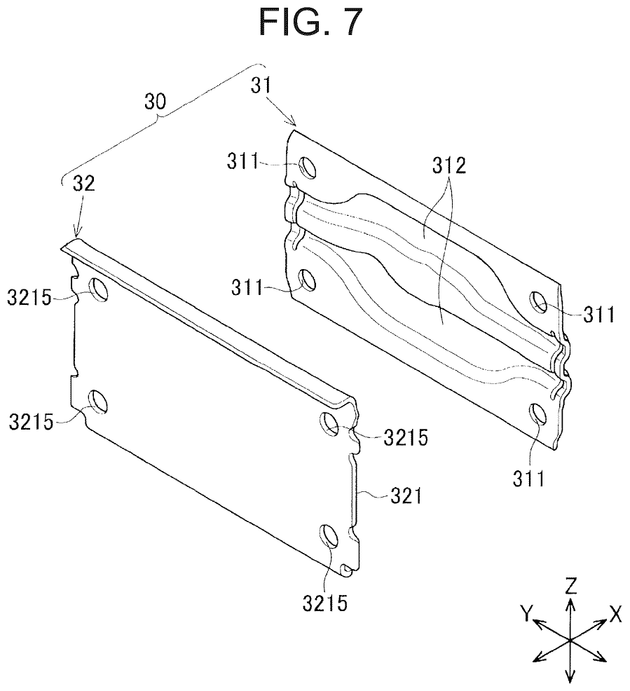

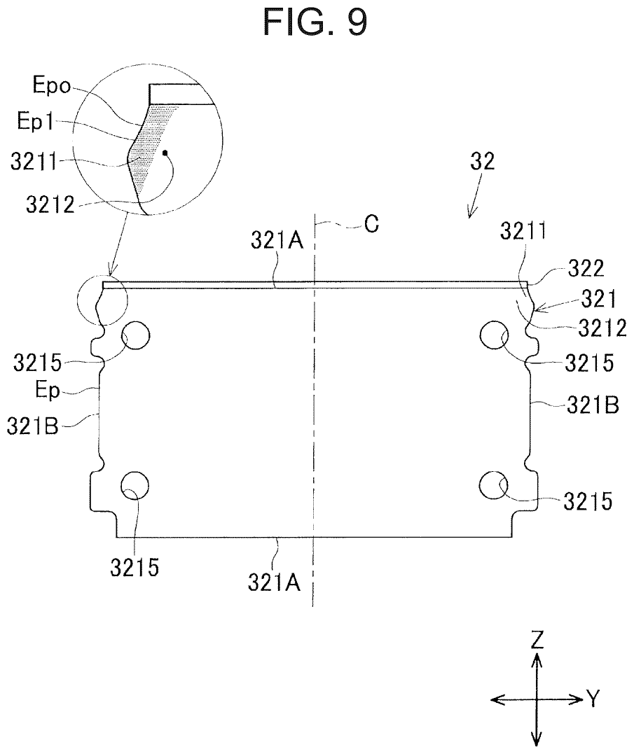

Specifically, as illustrated in FIG. 7 through FIG. 11, the terminal member 30 includes a first member 31 and a second member 32 aligning in the stated order towards an orientation away from the stack D in the X-axis direction, in a manner to be at least partially in contact with each other. When viewed in the X-axis direction, the terminal member 30 has a rectangular shape which is long in the Y-axis direction. In the terminal member 30 according to the present embodiment, a part 321 of the second member 32 has an outline in a rectangular shape when viewed in the X-axis direction. A first side and a second side, making up this outline in a rectangular shape, configure the first side 321A and the second side 321B of the above-mentioned terminal-member main-body 301 (refer to FIG. 9). That is, the part 321 of the second member 32 includes the first side 321A and the second side 321B.

The second member 32 includes: a second-member main-body 321 in a plate shape, extending in a direction orthogonal to the X-axis direction (Y-Z plane direction); and a brim portion 322 elongating from the second-member main-body 321, in an orientation away from the stack D in the X-axis direction.

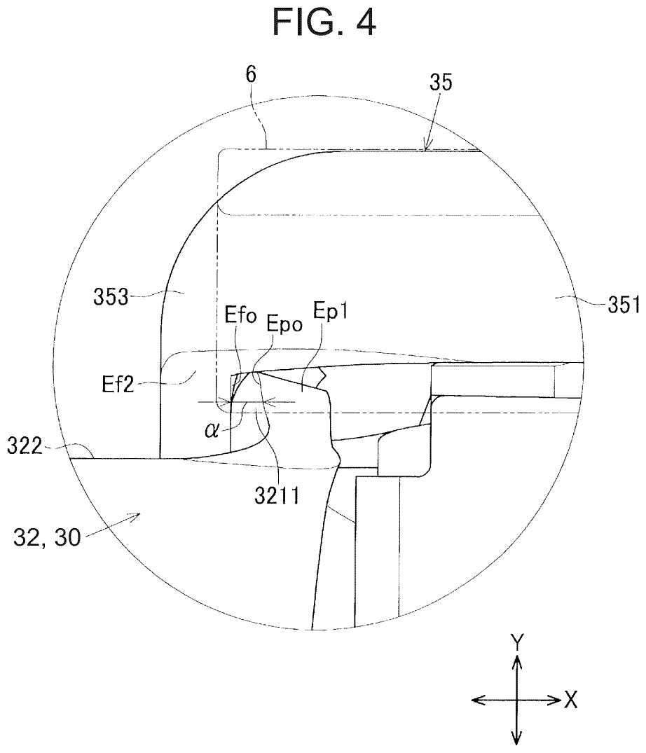

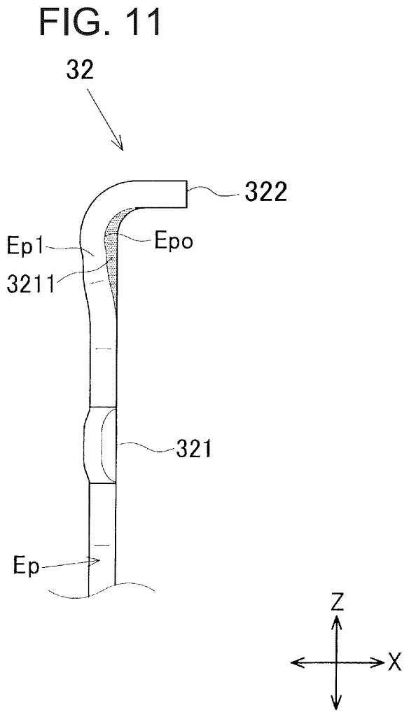

The second-member main-body 321 has a rectangular shape corresponding to the energy storage device 10 when viewed in the X-axis direction. Specifically, the second-member main-body 321 has a rectangular shape which is long in the Y-axis direction. Each corner portion (end) 3211 (the portion with a smoke in FIG. 9 and FIG. 11) on one side in the Z-axis direction of this second-member main-body 321 is curved with respect to a portion (adjacent portion) 3212 adjacent to that corner portion 3211, so as to be away from a portion (edge) EF2 of the coupling member 35, which opposes that corner portion 3211 (refer to FIG. 4).

This corner portion 3211 is a portion made by linking the first side 321A, which makes up an outline of the rectangular shape of the second-member main-body 321 and elongates along the Y-axis direction, to the second side 321B, which makes up the outline and elongates along the Z-axis direction. An edge (first edge) Ep1 of that corner portion 3211 is contained in an edge Ep of the terminal member 30 (specifically, the second member 32).

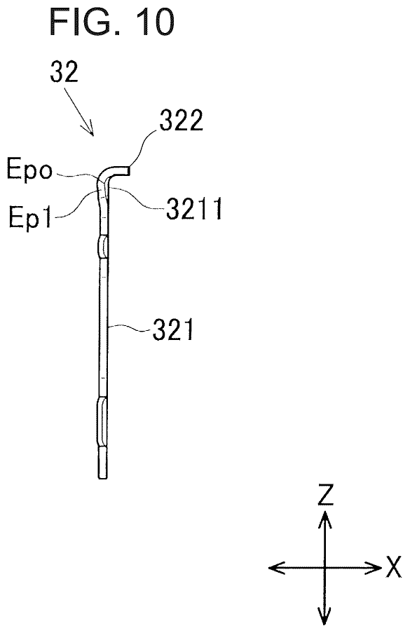

The adjacent portion 3212 according to the present embodiment is a portion extending in a direction orthogonal to the X-axis direction. The corner portion 3211 is curved with respect to the adjacent portion 3212 so that the first edge Ep1 approaches the stack D (refer to FIG. 10 and FIG. 11).

The second-member main-body 321 has second coupling through holes 3215 penetrating in the X-axis direction, in four corners thereof (i.e., each corner-edge portion in the rectangular shape). That is, the second-member main-body 321 has four second coupling through holes 3215.

The brim portion 322 is a plate-shaped portion elongating from an end of the second-member main body 321 on one side in the Z-axis direction (upward direction in FIG. 10), in an orientation away from the stack D in the X-axis direction, and elongating in the Y-axis direction.

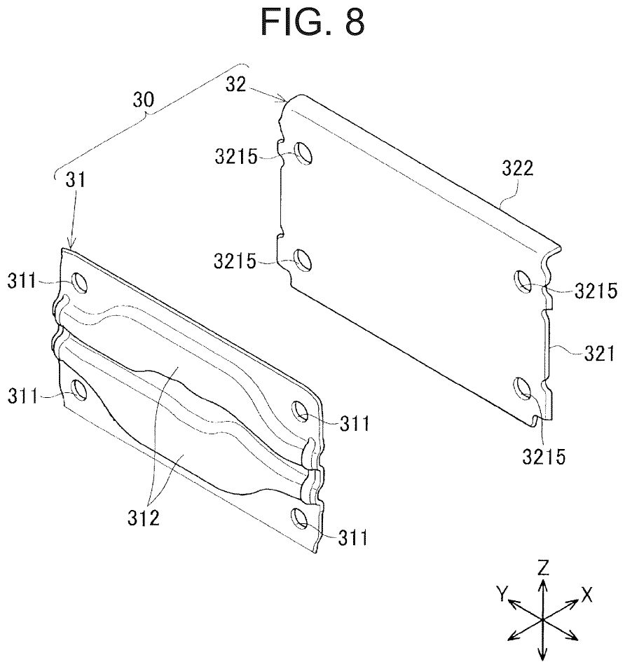

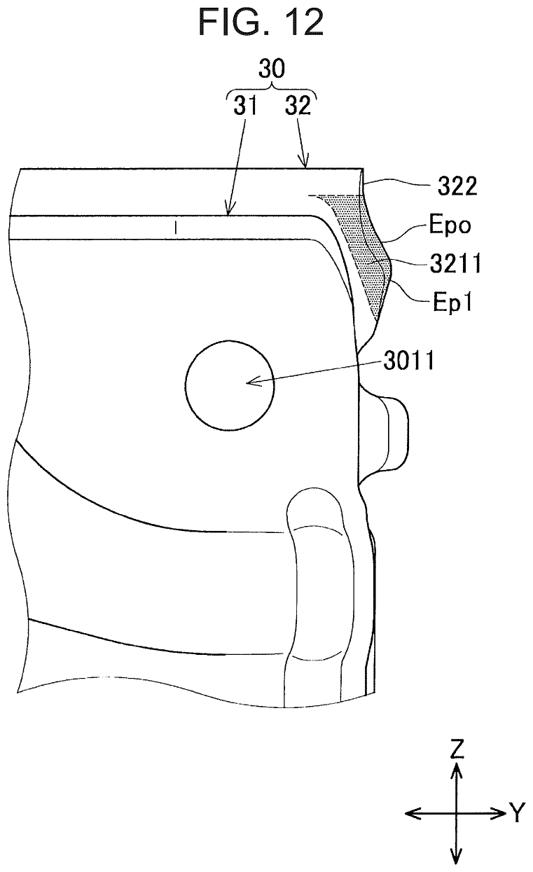

When viewed in the X-axis direction, the first member 31 has a rectangular shape corresponding to the second-member main-body 321 of the second member 32. Specifically, the first member 31 has a rectangular shape which is long in the Y-axis direction, and is overlapped on the second member 32. When viewed in the X-axis direction, this first member 31 is not disposed in an area overlapped with the corner portion (the end including the opposing portion Epo) of the second member 32, in the terminal member 30 (refer to FIG. 12). The first member 31 has first coupling through holes 311 penetrating in the X-axis direction, in four corners thereof (i.e., each corner-edge portion in the rectangular shape) (refer to FIG. 7 and FIG. 8). That is, the first member 31 has four first coupling through holes 311.

When viewed in the X-axis direction, these four first coupling through holes 311 overlap with respective second coupling through holes 3215, which are disposed in four corners of the second-member main-body 321. As a result, the second coupling through hole 3215 of the second-member main-body 321 is linked to the first coupling through hole 311 of the first member 31 in the X-axis direction, to configure the coupling through hole 3011 of the terminal member 30.

The first member 31 includes a plurality (two in the example of the present embodiment) of convex portions 312 protruding in an orientation approaching the energy storage devices 10 in the X-axis direction. The plurality of convex portions 312 respectively elongate in the Y-axis direction, and are disposed in the Z-axis direction with an interval therebetween. An apex (tip portion in the protruding direction) of each convex portion 312 abuts the third adjacent member 2C. The convex portion 312 according to the present embodiment is formed by drawing.

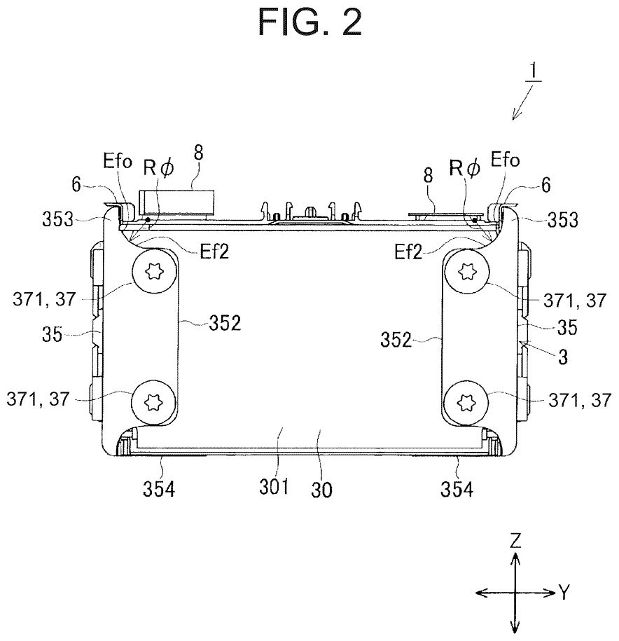

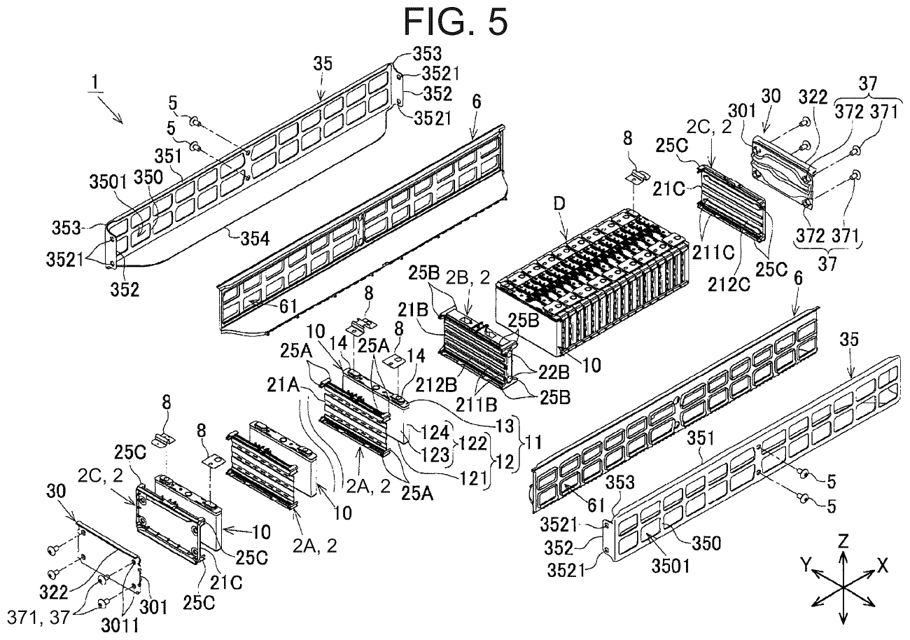

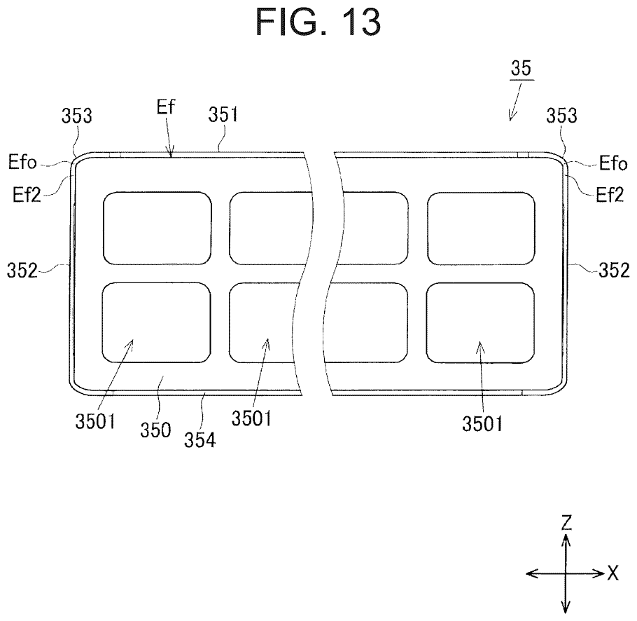

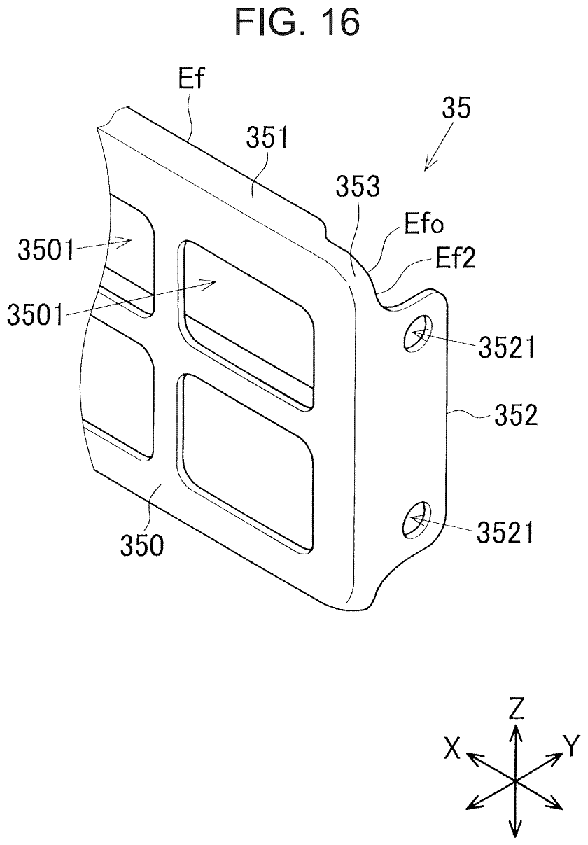

As illustrated in FIG. 1, FIG. 2, FIG. 5, and FIG. 13 trough FIG. 16, each of the pair of coupling members 35 includes: a coupling-member main-body 350 elongating in the X-axis direction in a position adjacent to the stack D in the Y-axis direction and elongating in the Z-direction; a first piece 351 elongating from an end of the coupling-member main-body 350 on one side in the Z-axis direction in an orientation approaching the stack D in the Y-axis direction, and elongating in the X-axis direction; a pair of second pieces 352 elongating from each end of the coupling-member main-body 350 in the X-axis direction in the Y-axis direction along a surface of the terminal-member main-body 301 on a side opposite to the stack D, and elongating in the Z-axis direction; and a coupling portion 353 coupling corresponding ends of the first piece 351 and the second piece 352. Each of the pair of coupling members 35 includes a third piece 354 elongating from an end of the coupling-member main-body 350 on the other side in the Z-axis direction in an orientation approaching the stack D in the Y-axis direction, and elongating in the X-axis direction. The coupling member 35 according to the present embodiment is formed by subjecting a plate member in a predetermined shape to drawing or bending.

The coupling-member main-body 350 is a plate-shaped portion extending in a direction orthogonal to the Y-axis direction, and includes at least one through hole 3501. When viewed in the Y-axis direction, the coupling-member main-body 350 according to the present embodiment has a rectangular shape which is long in the X-axis direction. The coupling-member main-body 350 includes a plurality of through holes 3501.

In the coupling member 35 according to the present embodiment, the first piece 351 is a band-shaped portion which is long in the X-axis direction.

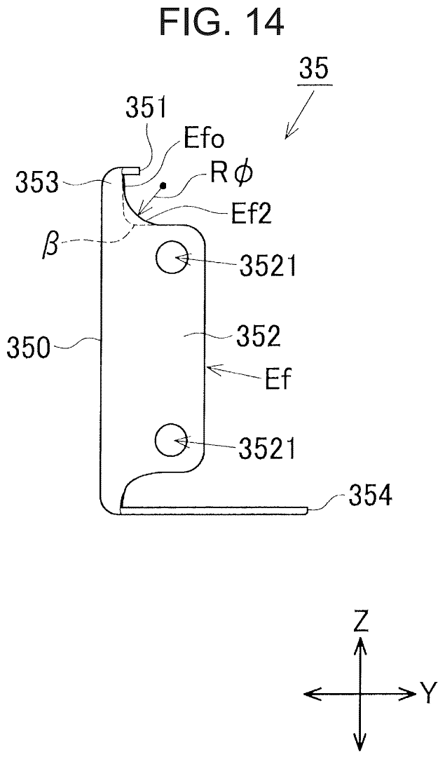

Each second piece 352 has a rectangular shape which is long in the Z-axis direction. Each second piece 352 has a size increasing in the Z-axis direction as it is closer to the coupling-member main-body 350, in its boundary portion (end closer to the coupling-member main-body 350 in the Y-axis direction) with the coupling-member main-body 350. As a result, when viewed in the X-axis direction, an edge (second edge Ef2) of the coupling member 35 from the coupling portion 353 towards the second piece 352 has an arc shape (refer to FIG. 14). This second piece 352 includes two through holes 3521 disposed with an interval therebetween in the Z-axis direction. Each through hole 3521 is disposed in a position corresponding to a position corresponding to a coupling through hole 3011 of the terminal member 30. Here, the coupling through hole 3011 of the terminal member 30 is a through hole in which the first coupling through hole 311 of the first member 31 is linked to the second coupling through hole 3215 of the second-member main-body 321.

The coupling portion 353 is a portion respectively coupling the coupling-member main-body 350 with the first piece 351 and the second piece 352. The coupling portion 353 according to the present embodiment is a curved portion.

The third piece 354 is a band-shaped portion which is long in the X-axis direction. The size of the third piece 354 in the Y-axis direction is larger than that of the first piece 351, except for both ends in the X-axis direction.

Each of the plurality of fastening members 37 fastens the terminal member 30 and the coupling member 35, while being inserted in the coupling through hole 3011 of the terminal member 30 and the through hole 3521 of the coupling member 35 (specifically, the second piece 352). Each fastening member 37 according to the present embodiment is configured by a bolt 371 and a nut 372.

The insulator 6 has an insulating property. This insulator 6 is disposed between the coupling member 35 and the stack D (specifically, the plurality of energy storage devices 10 included in the stack D). Specifically, the energy storage apparatus 1 includes a pair of insulators 6. Each insulator 6 covers a respective region of the coupling member 35, which at least opposes the plurality of energy storage devices. As a result, each insulator 6 insulates between the coupling member 35 and the plurality of energy storage devices 10. A through hole 61 having a size and a shape corresponding to those of each through hole 3501 of the coupling-member main-body 350 is provided, in each position of each insulator 6, corresponding to each through hole 3501 of the coupling-member main-body 350.

Each of the plurality of bus bars 8 is a conductive member, in a plate shape, such as metal. Each bus bar 8 makes external terminals 14 of energy storage devices 10 conductive to each other. The plurality of bus bars 8 according to the present embodiment couple (conduct), in series, the plurality of energy storage devices 10 included in the energy storage apparatus 1.

In the above-described energy storage apparatus 1, as illustrated in FIG. 2 to FIG. 4, FIG. 9, FIG. 11, and FIG. 13 to FIG. 16, in the terminal-member main-body 301 (specifically, the second member 32), (1) a first edge Ep1, which is an edge of the corner portion 3211 (the portion in which the first side 321A is linked to the second side 321B) and is included in the edge Ep of the terminal member 30 and (2) a second edge Ef2, which includes edges of the coupling portion 353 and the second piece 352 and is included in the edge Ef of the coupling member 35, include opposing portions Epo and Efo, respectively, opposing in a manner to intersect (that is, being in mutually twisting positions). The corner portion 3211 (end including the opposing portion Epo) of the terminal member 30 is curved with respect to the portion 3212 adjacent to that corner portion 3211, so as to be away from the opposing portion Efo of the counterpart (coupling portion) 353. As a result, a gap a (refer to FIG. 4) is formed between the edge Ep (the opposing portion Epo included in that edge Ep) of the terminal member 30 and the edge Ef (the opposing portion Efo included in that edge Ef) of the coupling member 35, which restrains interference between the edge Ep and the edge Ef. Moreover, the corner portion 3211 of the terminal member 30 is curved with respect to the portion 3212 adjacent to that corner portion 3211, so as to be away from the opposing portion Efo of the coupling portion (counterpart) 353. As a result, R (curvature radius: refer to reference numeral Rφ in FIG. 2 and FIG. 14) of the second edge Ef2 of the arc shape from the coupling portion 353 towards the second piece 352 of the coupling member 35 can be increased. Accordingly, compared to a case where the R of the second edge Ef2 is decreased (refer to the broken line β in FIG. 14) so as to avoid interference (abutting) between the edges Ep and Ef of the terminal member 30 and the coupling member 35, the value (magnitude) of the stress occurring in that portion can be restrained. Note that the R of the second edge Ef2 in the energy storage apparatus 1 according to the present embodiment is a curvature radius when viewed in the X-axis direction, and the second edge Ef2 has a substantially arc shape when viewed in the X-axis direction.

In the energy storage apparatus 1 according to the present embodiment, the terminal-member main-body 301 includes: an end 3211 including the opposing portion Epo; and the fixed portion F (including the adjacent portion 3212), to which the second piece 352 is fixed. In the terminal-member main-body 301, the end 3211 including the opposing portion Epo is adjacent to the fixed portion F (refer to FIG. 6). Specifically, when the height of the entire terminal-member main-body 301 in the Z-axis direction is divided into three, the end 3211 and the fixed portion F are disposed to be adjacent to each other in a range of about ⅓ of one side (upper side in FIG. 6) in the Z-axis direction. When the width of the entire terminal-member main-body 301 in the Y-axis direction is divided into six, the end 3211 and the fixed portion F are disposed to be adjacent to each other in a range of about ⅙ in the Y-axis direction, in both of one side and the other side (left and right sides in FIG. 6) in the Y-axis direction. In the energy storage apparatus 1, when a large binding force in the X-axis direction is exerted on the stack D by coupling the pair of terminal members 30 by the coupling member 35, this configuration can restrain interference between the edges Ep and Ef of the terminal member 30 and the coupling member 35, at the positions (opposing portions Epo and Efo) where a large force is likely to occur, when the edges Ep and Ef interfere with each other.

It is needless to say that the energy storage apparatus according to the present invention is not limited to the above-described embodiment, and various modifications can be made thereto within a scope not departing from the essence of the present invention. A configuration of another embodiment can be added to a configuration of an embodiment, and a part of a configuration of an embodiment can be replaced with a configuration of another embodiment. A part of a configuration of an embodiment can be omitted.

In the energy storage apparatus 1 according to the above-described embodiment, the corner portion (end including the opposing portion Epo) 3211 of the terminal member 30 is curved with respect to the portion 3212 adjacent to that corner portion 3211, so as to be away from the opposing portion Efo of the coupling member 35. However, the present invention is not limited to this configuration. The end (the coupling portion 353 and its surrounding portion) including the opposing portion Efo of the coupling member 35 may be curved with respect to the portion adjacent to that end, so as to be away from the opposing portion Epo of the terminal member 30. The corner portion (end including the opposing portion Epo) 3211 of the terminal member 30 and the above-mentioned end including the opposing portion Efo of the coupling member 35 may be respectively curved so as to be away from each other.

The energy storage apparatus 1 according to the above-described embodiment has a configuration in which, in each of the corner-edge portions (four corner-edge portions) on one side in the Z-axis direction, an end including the opposing portion Epo or Efo in at least one of the terminal member 30 and the coupling portion 353 of the coupling member 35 is curved with respect to the portion adjacent to that end, so as to be away from the opposing portion Epo or Efo of the counterpart. However, the present invention is not limited to this configuration. In the energy storage apparatus 1, each corner-edge portion on the other side in the Z-axis direction may have the above-described configuration. That is, in the energy storage apparatus 1, an end including the opposing portion Epo or Efo in at least one of the terminal member 30 and the coupling portion 353 of the coupling member 35 in at least one corner-edge portion, from among each corner-edge portion on one side and each corner-edge portion on the other side in the Z-axis direction, may have a configuration of being curved with respect to the portion adjacent to that end, so as to be away from the opposing portion Epo or Efo of the counterpart.

In the energy storage apparatus 1 according to the above-described embodiment, the first member 31 of the terminal member 30 is not disposed in an area overlapping with the corner portion (end including the opposing portion Epo) 3211 of the second member 32, when viewed in the X-axis direction (refer to FIG. 12). However, the present invention is not limited to this configuration. The first member 31 of the terminal member 30 may be disposed in an area overlapping with the corner portion (end including the opposing portion Epo) 3211 of the second member 32, when viewed in the X-axis direction, and the portion (portion overlapping when viewed in the X-axis direction) of that first member 31 corresponding to the corner portion 3211 of the second member 32 may be curved in a direction away from the second member 32 (i.e., not in contact with the second member 32).

In the above-described embodiment, the energy storage device is used as a chargeable and dischargeable non-aqueous electrolyte secondary battery (e.g., lithium-ion secondary battery). However, the energy storage devices may be of any type and size (capacity). In the above-described embodiment, a lithium-ion secondary battery was described as an example of the energy storage devices. However, the energy storage device is not limited to this. The present invention is also applicable to various secondary batteries, primary batteries, and energy storage devices of capacitors such as electric double layer capacitors.

### DESCRIPTION OF REFERENCE NUMERALS

1 . . . energy storage apparatus
2 . . . adjacent member
2A . . . first adjacent member
21A . . . first main-body portion
25A . . . first restricting portion
2B . . . second adjacent member
21B . . . second main-body portion
211B . . . convex stripe
212B . . . opposing surface
22B . . . second fastening member
25B . . . second restricting portion
2C . . . third adjacent member
21C . . . third main-body portion
211C . . . convex stripe
212C . . . opposing surface
25C . . . third restricting portion
3 . . . holding member
30 . . . terminal member
301 . . . terminal-member main-body
3011 . . . coupling through hole
3012 . . . through hole circumferential portion
31 . . . first member
311 . . . first coupling through hole
312 . . . convex portion
32 . . . second member
321 . . . second-member main-body
321A . . . first side
321B . . . second side
3211 . . . corner portion (end including opposing portion)
3212 . . . adjacent portion (portion adjacent to corner portion)
3215 . . . second coupling through hole
322 . . . brim portion
35 . . . coupling member
350 . . . coupling-member main-body
3501 . . . through hole
351 . . . first piece
352 . . . second piece
3521 . . . through hole
353 . . . coupling portion
354 . . . third piece
37 . . . fastening member
371 . . . bolt
372 . . . nut
5 . . . first fastening member
6 . . . insulator
61 . . . through hole
8 . . . bus bar
10 . . . energy storage device
11 . . . case
12 . . . case main-body
121 . . . closing portion
122 . . . drum portion
123 . . . long wall portion
124 . . . short wall portion
13 . . . cover plate
14 . . . external terminal
500 . . . power supply apparatus
501 . . . battery cell
502 . . . battery cell stack
503 . . . end plate
504 . . . bind bar
505 . . . separator
506 . . . main-body plate
507 . . . fastened main surface
508 . . . first bent piece
509 . . . second bent piece
510 . . . third bent piece
511 . . . fourth bent piece
C . . . center of second member in Y-axis direction
D . . . stack
Ef . . . edge of coupling member
Ef2 . . . second edge
Efo . . . opposing portion
Ep . . . edge of terminal member
Ep1 . . . first edge
Epo . . . opposing portion
F . . . fixed portion
R . . . flow path
Rφ . . . curvature radius
a . . . gap

1. An energy storage apparatus comprising:
a stack including a plurality of energy storage devices aligning in a first direction;
a pair of terminal members sandwiching the stack in the first direction; and
a coupling member coupling, with each other, corresponding ends in a second direction orthogonal to the first direction of the pair of terminal members, wherein
at least one terminal member of the pair of terminal members includes a terminal-member main-body extending in a direction orthogonal to the first direction,
when viewed in the first direction, the terminal-member main-body includes: first sides elongating along the second direction at respective ends in a third direction orthogonal to each of the first direction and the second direction of the terminal-member main-body; and second sides elongating along the third direction at respective ends in the second direction of the terminal-member main-body,
the coupling member includes:
a coupling-member main-body elongating in the first direction at a position adjacent to the stack in the second direction;
a first piece elongating towards the stack in the second direction from an end of the coupling-member main-body on one side in the third direction and elongating in the first direction;
a second piece elongating in the second direction along a surface of the terminal-member main-body on a side opposite to the stack, from an end of the coupling-member main-body on one side of the first direction and elongating in the third direction; and
a coupling portion coupling corresponding ends of the first piece and the second piece, and
each of a first edge being an edge of a portion in which the first sides are linked to the second sides in the terminal-member main-body and a second edge including respective edges of the coupling portion and the second piece includes an opposing portion opposing in a manner to intersect, and
an end of at least one of the terminal member and the coupling portion, which includes the opposing portion, is curved with respect to a portion adjacent to the end, so as to be away from an opposing portion of an other of the terminal member and the coupling portion.

2. The energy storage apparatus according to claim 1, wherein
the terminal-member main-body includes: the end which includes the opposing portion, and a fixed portion to which the second piece is fixed, and
in the terminal-member main-body, the end including the opposing portion is adjacent to the fixed portion.

3. The energy storage apparatus according to claim 1, wherein
the terminal-member main-body includes a first member and a second member aligning in the stated order towards a direction away from the stack in the first direction and being in contact with each other,
the second member includes the end including the opposing portion, and
either a portion of the first member, which corresponds to the end of the second member including the opposing portion, is not in contact with the second member, or the first member is not disposed in an area overlapping the end of the second member including the opposing portion, when viewed in the first direction.
